(19) United States
(12) Patent Application Publication
(10) Pub. No.: US 2011/0130048 A1
(43) Pub. Date: Jun. 2, 2011

(54) PLUG CONNECTOR AND PLUG CONNECTOR SET

(75) Inventors: Thomas Haunberger, Bad Reichenhall (DE); Manfred Stolle, Bad Aibling (DE)

(73) Assignee: KATHREIN-WERKE KG, Roseheim (DE)

(21) Appl. No.: 13/055,235

(22) PCT Filed: Jul. 9, 2009
(86) PCT No.: PCT/EP2009/004987

§ 371 Date: Jan. 21, 2011

(30) Foreign Application Priority Data
Jul. 24, 2008 (DE) 10 2008 034 583.0

(51) Int. Cl. H01R 24/00

(52) U.S. Cl. 439/660

(57) ABSTRACT

An improved plug connector has an electrical outer conductor contacting section of an outer conductor of the plug that is designed to run separately in the radial direction from the axial stop, such that the high frequency signal path formed on the inner wall of the outer conductor between the outer conductor of the plug connector and a further outer conductor of a further plug connector for connection thereto runs over the electrical contacting device running in the radial direction. A mechanical action axial stop on the connector or plug side of the plug connector is provided outside the high frequency signal path provided by the radial contacting device.

The invention relates to a connector according to the preamble of claim 1 and a connector assembly according to the preamble of claim 16.

Connectors in general are used to disconnect and/or connect electrical lines, in order to transmit current and/or primarily electrical signals thereby. The connectors may be multiple or single connectors.

Coaxial connectors are extremely important in the field of connectors. They have an inner conductor and an outer conductor and usually comprise an outer-conductor shield, with a dielectric normally being used to isolate the inner conductor galvanically from the outer conductor. Instead of a dielectric in the form of a solid object, it is also possible to use cable insulation to hold the inner conductor in a central position.

The huge range of coaxial conductors are classified according to application.

For instance, the following connectors are known in the field of radio frequency engineering: BC connectors, F connectors (for example for radio frequency transmission up to 5 GHz), SMA connectors (for frequency ranges from 1 to 18 GHz), UHF connectors and, for instance, also 7-16 (DIN) connectors based on IEC standard EN 60 169-4.

In particular, the latter connectors, the 7-16 (DIN) connectors based on IEC standard EN 60 169-4, are robust RF connectors that are generally used up to 7.5 GHz for example. They are primarily used with higher RF powers when the mechanical connection is also exposed to environmental conditions. Hence these connectors are mainly also employed in antenna technology and, in this case, particularly also in mobile radio communication systems such as base stations.

According to the DIN standards, connectors can be designed both with a pin contact and with a socket contact. A pin contact (male contact) is a contact for which electrical contact is made on the outer surface of the contact part (pin). A connector having a socket contact (female contact) involves a contact for which electrical contact is made on the inner surface of the contact part. The types of connector can be classified as a plug or a coupler: a plug is a connector that comprises the moving part of the locking mechanism; the coupler is the mating part to the plug, and is sometimes also called the “socket”. A coupled connector assembly ultimately comprises two or more connectors that are connected together, if necessary using an intermediate connector or connecting parts (in the case of a connector using connecting parts).

Thus a coupled connector assembly, as is also known, for example, from DE 18 13 161 U, comprises two coupled connectors, wherein the one connector, for example, may be a connector having a pin contact (i.e. characterised by a pin-shaped inner-conductor plug) and the other connector may be a connector having a socket contact (characterised by its inner-conductor socket contact). In principle, the connectors could also be designed with an hermaphroditic contact, for which the inner conductors in both coupled connectors have the same design or else cannot be described as either pin-shaped or socket-shaped. When the plug and socket are plugged together axially, contact is made between the inner conductors and corresponding contact is made between the outer conductors.

If two connectors are to be coupled together, they can be plugged together, i.e. pushed together, so far axially until an associated outer-conductor ring comes up against an axial stop limit on an outer conductor of the other connector (front face), and this also guarantees that electrical contact is made between the outer conductors of the two connectors to be coupled.

In order to guarantee good intermodulation properties for such radio frequency connections (RF connections), it is necessary for high contact pressures or capacitive couplings to be present between the components. The compact construction of connectors means that capacitive couplings are mostly not possible because there is not enough space here. In addition, capacitive couplings often have a radio frequency bandwidth that is too narrow and they do not allow any DC transmission and/or data transfer.

High contact pressures have the disadvantage that very high-quality materials need to be used that can withstand the high pressures. Hence, for example, a plastic outer conductor cannot be used in a 7-16 (DIN) connector based on IEC standard EN 60 169-4, i.e. it is not possible to use a plastic outer conductor coated in a conducting layer or a plastic coupling nut to make a permanent, tight axial connection between plug and socket, because this cannot guarantee the same mechanical and electrical properties over prolonged periods (especially also when one considers that such a connection may potentially be exposed to large temperature variations). The relaxation that occurs particularly with plastic would result in a change in the mechanical contact pressure and hence also in a change in the electrical properties. Such situations give rise especially to intermodulation problems, which need to be avoided at all events.

For intermodulation measurements (IM measurements), the RF connectors must also always be tightened with a minimum torque in order that the recommended contact pressure is achieved. The high tightening torque is also necessary in order to compress the integral seal.

Proceeding from this prior art, it is the object of the present invention to create an improved connector (having pin contact and/or having socket contact), and at the same time the improved connector shall preferably be compatible for connection, i.e. the connector improved according to the invention shall preferably be able to interact without difficulty with the respective standardised mating part, which means that the standardised mating part to the connector modified according to the invention does not itself need to be adapted. Thanks to this backwards compatibility, it is possible to fit and to use connectors according to the invention also with conventional interacting connectors. In addition, the invention shall not only improve a connector or two interacting connectors, but shall also create an improved, coupled connector assembly.

As regards the connector according to the invention, the object is achieved according to the features given in claim 1, and as regards the (coupled) connector assembly according to the invention, the object is achieved according to the features given in claim 16. The subclaims contain advantageous embodiments of the invention.

The present invention takes a completely new approach, which produces surprising and considerable advantages over the prior art.

The crux of the invention is that the mechanically imposed stop limit, which limits relative to each other the maximum insertion distance, i.e. the insertion depth, between two connectors to be coupled, is separated from the function of making electrical contact between the two outer conductors, which interact in the coupled state, of the connectors.

According to the prior art, even to carry out measurements, sufficiently high torques had to be exerted continuously on a coupling nut on the connector concerned in order thereby to hold in contact the one connector, e.g. having the pin contact (which, for the sake of simplicity, is referred to below for short as a pin-shaped connector or even more succinctly as a plug), with the other connector, e.g. having the socket contact (which is referred to below also for short as a socket-shaped connector or sometimes even more succinctly as a socket), by sufficient axial forces, with the connectors interconnected as far as the stop. This is because applying the sufficiently high torques to produce the sufficiently high axial contact pressures between the outer-conductor sections of the two connectors that can be coupled together is necessary in order to guarantee the appropriate contact pressure to produce the desired electrical contact between the outer conductors of the two interacting connectors.

This function is now separated according to the invention. Whilst a stop limit is provided to make the mechanical connection between the plug-shaped connector and the socket-shaped connector, the electrical signal path is separate therefrom, so that it is already guaranteed that sufficient, uniform and constant outer-conductor contact is made between socket and plug even when the plug-shaped connector and socket-shaped connector are still not completely interconnected and a provided coupling nut is still not tightened into its final position.

The generic document DE 18 13 161 U shows a plug for coaxial RF connections in which the one outer-conductor contact part, which contains slits parallel to the axis and is designed to have an outwards spring action, has contact segments that protrude radially outwards, which interact with the inwards-facing surface of the second outer conductor of the second contact part. However, the spring-loaded tabs provided with the contact segments at the same time also rest in an axial direction with their leading front end against a corresponding annular shoulder of the outer conductor of the second contact part, and therefore not only does this axial stop set up the axial pressures but it also establishes the RF signal path. This is because the RF signal path always spreads over the inside surfaces (which are not shielded from the interior) of the outer conductors between which contact is to be made, so that in this case the RF signal path is only made via the axial stop between the two outer conductor sections between which contact is to be made, while the contact segments projecting radially outwards in the form of annular contact ridges are irrelevant to the RF signal path.

This means that the disadvantages described with regard to the prior art remain, whereby high tightening torques for the front contact between the outer conductor of the socket-shaped connector with the outer conductor of the pin-shaped connector are no longer necessary, because now electrical contact is not made axially (the axial mechanical stop limit between the two connectors to be coupled), but separately therefrom, radially via contacts, in particular via spring contacts.

In addition, the invention has the following advantages:
Even when carrying out measurements (i.e. when the coupling nut is not tightened to its maximum), the fact that contact is made with the inner conductor is in itself enough affirmation and proof that contact between the outer conductors is working electrically. The larger diameter of the outer conductor means that there are actually lower currents here, so that making contact is hence also less critical.
The mechanical end stop for inducing the torque (and for the aforementioned seal between the two connectors to be coupled) is effected according to the invention, for example in the connector having a socket-shaped inner-conductor contact, outside the radio-frequency signal path. To achieve this, in the connector having a socket contact, a generally annular groove is provided between the outer-conductor thread and the outer-conductor spring-contacts, wherein the mechanical depth, running in an axial direction, of this groove is preferably selected so that, for a connector in question interacting with said socket-contact connector, for example for a connector having a pin contact, a defined axial stop is provided between the two connectors that can be plugged together, until the one connector can be inserted as far as it will go into the other connector. This can be implemented in a vast range of connector types, in particular also in the 7-16 (DIN) connectors based on IEC standard EN 60 169-4 that were mentioned at the outset. It is mentioned merely for the sake of completeness that part of the applied torque acts not only between the two stops of the coupled connectors but part of this torque also acts on the seal provided between the two coupled connectors. Alternatively, between said outer-conductor spring contacts and an outer-conductor stop, an insulating element can also be used on the connector that is provided with a socket outer conductor. Even in this case, the maximum axial contact pressure between the two interacting outer conductors is acting via said outer-conductor spring elements, albeit via an insulator that is provided at the end of the outer-conductor spring element and acts between the two interacting outer conductors of the two coupled connectors. Unlike the prior art, there is hence at this point no galvanic connection between the front contact of the socket outer conductor lying outside and the plug outer conductor, which is engaged therein and hence lying inside, of the two interacting conductors. The signal path is effected separately therefrom, again radially via the spring contacts of the outer conductor of the one connector to the outer-conductor ring of the other connector. Hence there is no galvanic outer-conductor front contact between the two interacting connectors. The insulation can be designed here so that the spring-contact action of the spring contacts is actually intensified further on tightening the plug (gland principle).
Relaxation of the material (e.g. for plastic or a composite) has no impact on the electrical contacts e.g. intermodulation.
The connector according to the invention having a plug-shaped outer conductor lying inside can be used with conventional connectors that interact with said connector and are provided with a corresponding socket-shaped outer conductor lying outside. Likewise, a connector according to the invention having a socket outer conductor lying outside can be used with a conventional connector that interacts with said conductor and is provided with a corresponding plug outer conductor lying inside. In this respect, the respective connector according to the invention is compatible for connection, i.e. even when using a connector according to the invention, there is no need to modify the mating part that interacts with said connector, but standardised connectors can be used, which can interact with the connector according to the invention. This applies to the vast range of socket and plug types, in particular also to 7-16 (DIN) connectors based on IEC standard EN 60 169-4. Hence, in this respect, there is no restriction on operation. In other words, it is also possible to use commercial or standardised connectors of a particular connector type in question, including commercial or standardised 7-16 (DIN) connectors based on IEC standard EN 60 169-4. The principle according to the invention can therefore also be applied to all other connector families, for example N connectors, EIA connectors etc.
Electrical tests (for example VSWR tests or IM tests) can be performed without tightening a coupling nut, because there is no need for axial front contact between the outer conductors.
The spring-contact ring can be designed here so that it does not extend beyond the outer-conductor thread viewed in the axial direction, i.e. in the axial direction does not protrude beyond the open end of the outer-conductor thread, but terminates at the same height or preferably already terminates before the edge of the outer-conductor thread. Hence such a contact can be fitted even without a protective cap such that the sensitive outer conductor or outer-conductor contact is mechanically protected.

In other words, the invention can be applied to connectors or (coupled) connector assemblies, one connector of which has a socket outer-conductor contact (for which contact is made on the inner surface of the contact part) and the respective other connector has a pin outer-conductor contact (for which electrical contact is made on the outer surface of the contact part). When mention is made of a pin-shaped contact or pin outer-conductor contact, this means that, with reference to the outer conductor, the pin-shaped contact is sleeve-shaped or like a sleeve in form, because said inner-conductor contact-making between the two connectors is again provided inside said pin-shaped contact. The invention can also be applied to pin contacts or socket contacts (unattached connectors, connectors to cables, fixed connectors etc.). The types of connectors can here be said plugs or couplers (sockets). In particular, the invention can also be applied to intermediate connectors or adapters.

The invention is described in more detail below with reference to drawings, in which specifically:

FIG. 1 shows a schematic axial section through a connector according to the invention having a socket according to the invention;

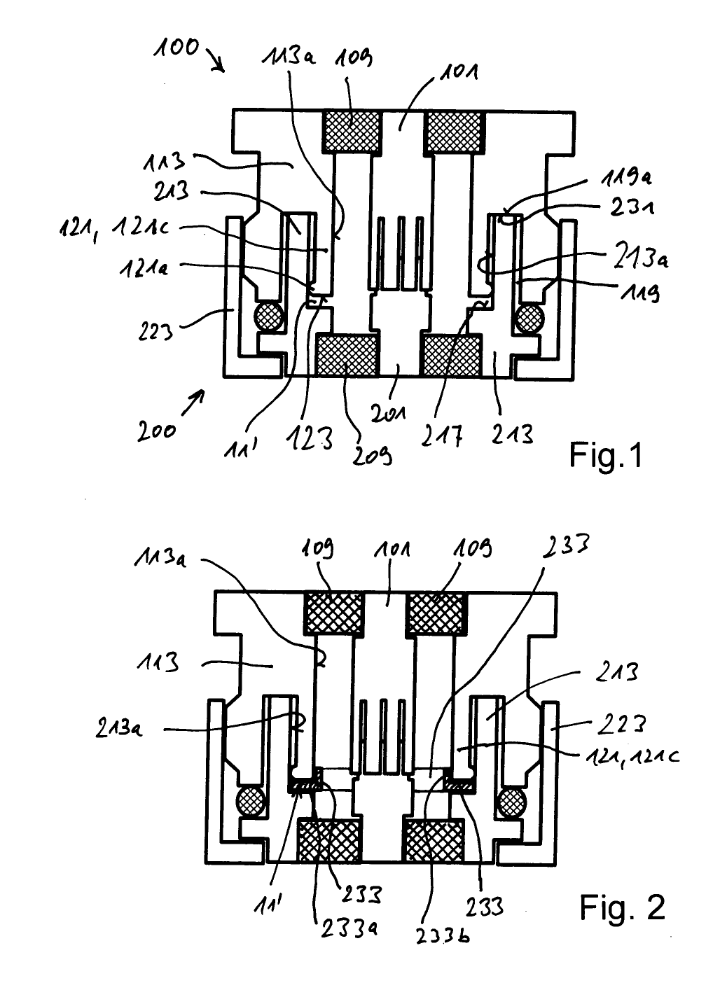

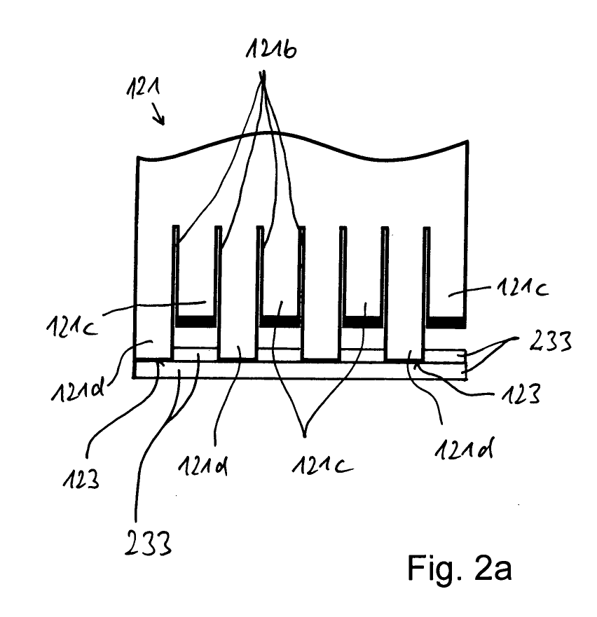

FIG. 2 shows a diagram similar to FIG. 1 involving a slightly modified exemplary embodiment;

FIG. 2a shows a development of the outer conductor of the coupler in an exemplary embodiment that differs from FIG. 2;

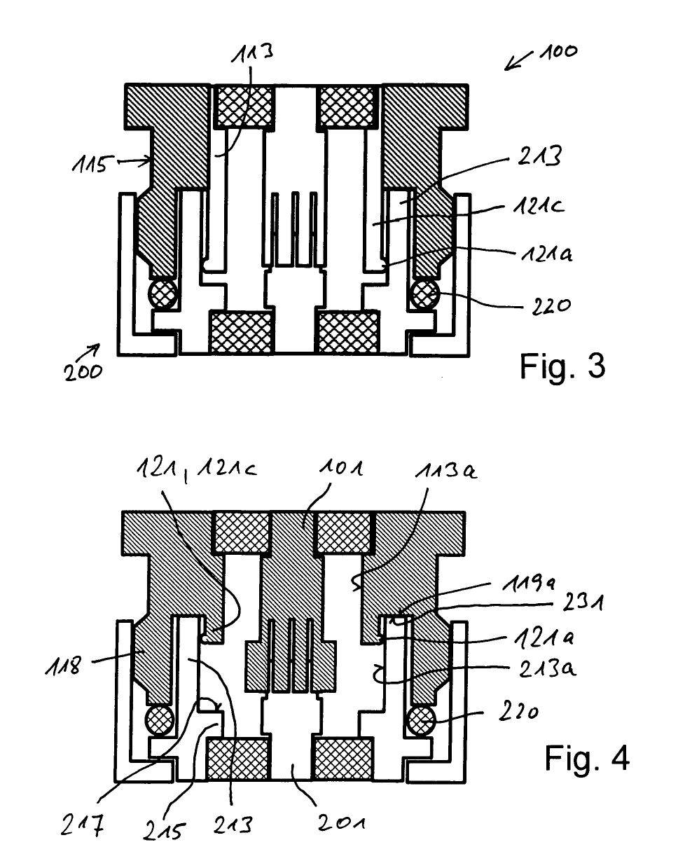

FIG. 3 shows an exemplary embodiment that differs from FIG. 1, in which the electrically conducting outer conductor of the socket is encircled by a socket housing provided with an external thread and made of a plastics material;

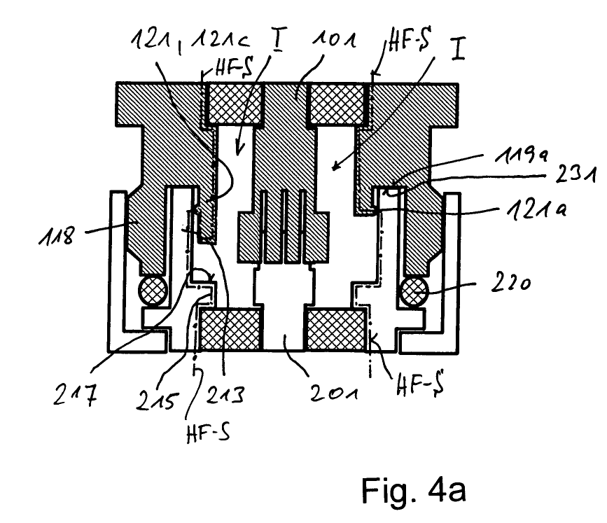

FIG. 4 shows an exemplary embodiment that differs slightly from FIG. 1 having a socket outer-conductor contact section that has been shortened in the axial direction;

FIG. 4a shows an exemplary embodiment that differs slightly from FIG. 4 for the purpose of illustrating the RF signal path over the inside walls of the outer conductors and the radial contact-making arrangement;

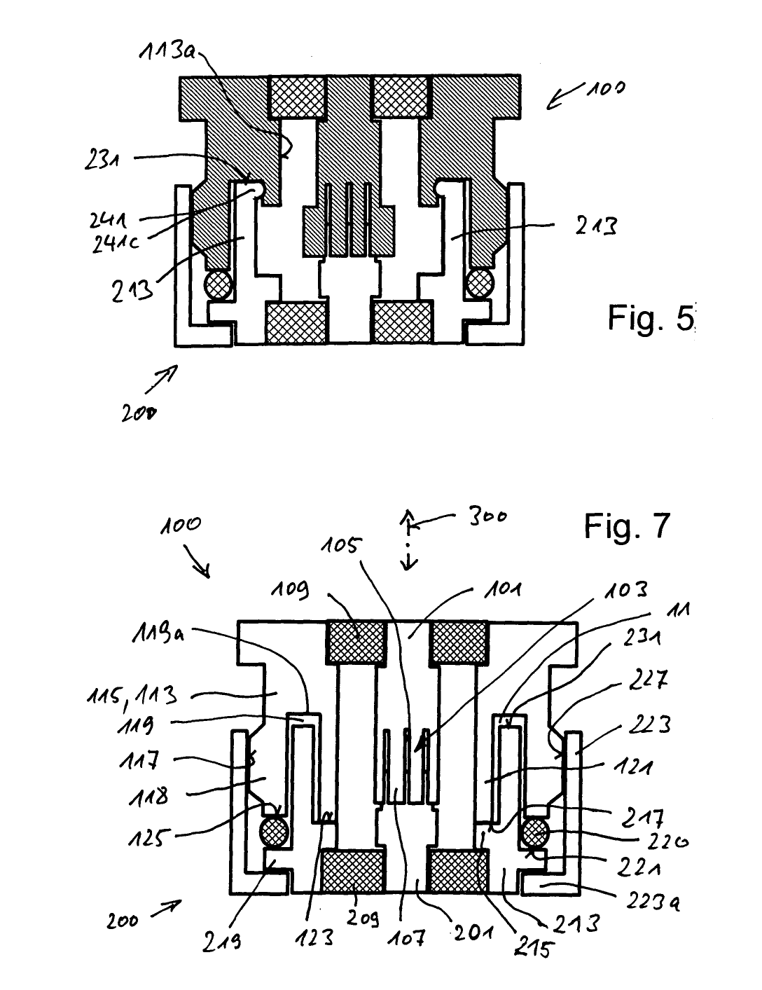

FIG. 5 shows a modified exemplary embodiment having a plug designed and modified according to the invention and a socket designed and modified according to the invention;

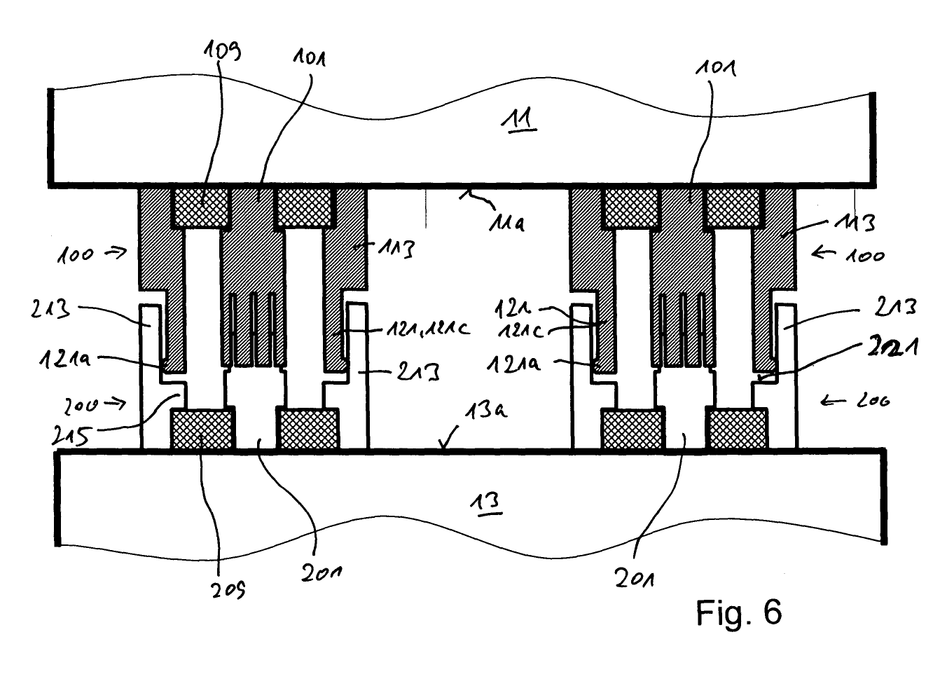

FIG. 6 shows an exemplary embodiment in which a connection according to the invention can be used as a port connection having an axial adapting device between two electrical/electronic devices, in particular between an antenna housing and an electrical device for a TMA amplifier; and

FIG. 7 shows a schematic diagram that can be compared with FIG. 1 of an axial section through a connector known from the prior art.

First, a coupled connector assembly according to the prior art having two interconnected connectors shall be presented and described with reference to FIG. 7, wherein one of the connectors is a connector having a pin contact for making inner-conductor contact and the other connector is a connector having a socket contact for making inner-conductor contact. In this respect, the first type is also referred to below for short as a plug and the other connector interacting therewith as a coupler, regardless of whether they are moveable connectors or fixed connectors, i.e. permanently fitted connectors, which usually are also called housing connectors and are fitted on a housing or in a device. It should also be mentioned here that irrespective of the embodiment of the connector with a pin contact or a socket contact for the inner conductor, the same principle also applies to the outer conductor, i.e. a connector comprises either a socket outer conductor (for which electrical contact is made on the inner surface of the outer contact) or a plug outer conductor (for which electrical contact is made on the outer surface of the plug outer conductor), in the latter case the plug outer conductor being formed in the shape of a hollow cylinder or at least generally like a hollow cylinder. For coding reasons, the connector having a pin-shaped inner-conductor contact is often provided with a socket-shaped outer-conductor contact, whereas the connector having a socket-shaped inner-conductor contact is equipped with a plug-shaped outer-conductor contact, i.e. the contact surface, in this case making contact with the outer conductor, lies on the outside surface of this hollow cylindrical outer conductor.

The coupled connector assembly shown in FIG. 7 hence comprises two interconnected connectors, of which one is referred to below also as a coupler (socket) 100 and the other also as a plug 200, which are interconnected along an axial axis 300 as far as their stop limit. Both the plug and the coupler may be movable parts. One of the two can also be permanently fitted. It is also possible, however, that both are permanently fitted, and two devices having permanently fitted connectors can be electrically connected, if necessary also by the interconnection of an intermediate connector or adapter.

The connector 100 referred to sometimes as a coupler 100 comprises for this purpose a socket-shaped inner conductor 101 comprising a socket-shaped inner-conductor spring cage 103. This socket-shaped inner-conductor spring cage 103 has a plurality of generally axial slits 105 around the circumference, which extend from the open end of the inner conductor 101 over a certain axial distance, thereby forming individual inner-conductor contact springs 107 present in the inner conductor socket 101.

This socket inner conductor 101 is held by means of a socket insulator or socket insulator ring 109 lying offset in the unattached inner-conductor spring cage 103, and is thereby galvanically isolated from the socket outer conductor 113. Said socket insulator ring 109 is referred to below sometimes also as the socket-end centering washer 109. As a different option, the cable-centering mechanism of a cable connected to the connector can also be used to hold the inner conductor in the centre.

The coupler outer conductor 113 encircles the coupler inner conductor 101. The coupler outer conductor 113 is designed here in the form of a coupler outer-conductor housing 115 and has an external thread 117 on its outer circumference along an axial partial length.

In addition, an annular outer-conductor groove 119 is made in the coupler outer conductor 113 that runs from the contact-making and plug end of the outer conductor (the end that faces downwards in FIG. 7), whereby a coupler outer-conductor threaded body 118 is separated from the coupler outer-conductor contact-making section 121 along an axial partial length of the coupler. In the selected exemplary embodiment, the coupler outer-conductor contact-making section 121 and the coupler outer-conductor threaded body 118 having the outer-conductor thread 117 are an electrically conducting component made of a single part, which forms the coupler outer-conductor housing 115.

In the illustrated example, the front face 123 on the coupler outer-conductor contact-making section 121 extends beyond the front face 125 on the coupler outer-conductor threaded section 117.

A coupler 100 of this form can be interconnected with said plug 200 in an axial direction 300. The coupler 100 hence likewise has a connecting or insertion end on the end facing the coupler, via which the two connectors, one in the form of the coupler 100 and one in the form of the plug 200, can be interconnected.

The plug 200 here comprises a plug inner conductor 201, which is plug-shaped or pin-shaped in form, and which in the contacted state engages in the coupler inner-conductor spring cage 113, whereby the contact made by the inner-conductor contact springs 107 of the coupler with the outer circumference of the plug inner conductor 201 can make the galvanic contact between the inner conductor of the socket and the inner conductor of the plug. The axial overlap between the inner-conductor spring cage 113 of the socket and the pin-shaped or plug-shaped inner conductor 201 of the plug is provided to a sufficient extent.

This plug inner conductor 201 is encircled by a plug outer conductor 213, the plug inner conductor 201 being held and galvanically isolated from said plug outer conductor in a manner similar to that in the coupler by means of a plug insulator, a plug insulator ring 209 or what is called a plug-end centering washer 209, wherein the centering washer can be made of (any) suitable material, for example of plastic. In this case it is again possible to dispense with the insulator 209 if the cable insulation is used to hold the inner conductor in a central position.

The plug outer conductor 213 has a ledge or annular ledge 215 projecting radially inwards, which, facing the coupler 100 in an axial direction, forms in the illustrated embodiment an annular stop shoulder 217.

Likewise, a ledge or annular ledge 219 projecting radially outwards is provided on the plug outer conductor 213, which, facing the coupler 100 in an axial direction, similarly forms an external shoulder 221 which is annular in the illustrated embodiment.

In addition, a coupling nut 223 is provided, which is made in the form of a coupling cap or the like, which is provided with a lip 223a on the front end, by means of which the plug can be carried along with its outer conductor, for example by means of the outwards-projecting ledge 219, when the coupling nut 223 is screwed onto the external thread 117 on the coupler outer-conductor housing 115 by its internal thread 227. Said coupling nut 223 can also be provided, however, on the other connector, i.e. on the coupler 100.

To produce a mechanically sufficiently tight connection, suitably high torques must be exerted on the coupling nut 223 until the plug and the coupler are pressed against each other by sufficiently high axial forces at their stop limit acting in the axial direction, whereby the maximum interconnection travel (insertion depth) is limited. When tightening the coupling nut 223, it is in fact the front face 123 of the annular outer-conductor contact-making section 121 of the coupler that comes up against the stop shoulder 217 of the plug 200, and produces here the maximum axial tensioning forces, induced by the torque, between the outer conductor of the coupler 100 and of the plug 200. The electrical signal path is simultaneously established here between the front face 123 of the coupler outer-conductor contact-making section 121 and the electrically conducting stop shoulder 217 of the plug 200.

It can also be seen from the drawings that the plug outer conductor 213 shaped as a hollow cylinder engages in the annular or hollow cylindrical outer-conductor groove 119 of the socket 100 without making any other contact. It is apparent from FIG. 7 that when coupler and plug are interconnected with full axial torque, the annular front face 131 of the outer conductor 121, which is its leading front face in the insertion direction, comes to lie at a distance 11 from the groove floor 119a of the hollow cylindrical coupler outer-conductor groove 119, and therefore the full contact-making forces between coupler and plug only act between the front face 123 of the socket and the stop shoulder 217 of the plug.

Between the outside end face 125 on the plug-facing limiting end of the coupler outer-conductor housing 115 and the stop shoulder 221 of the ledge 219 projecting radially outwards is inserted an additional seal 220, in particular a sealing ring or an O-ring, which is compressed between the end face 125 of the coupler outer-conductor housing 115 and the outside-lying annular ledge 219 of the plug in order to ensure that the connector is sealed to the required degree against environmental conditions.

A first variant of the solution according to the invention is now described and illustrated with reference to FIG. 1.

The solution according to the invention referring to the axial section shown in FIG. 1 differs from the known solution of FIG. 7 in that an axial stop limit is now produced between plug and coupler by the plug outer conductor 213 (which is sometimes referred to below also as the plug outer conductor 213 lying outside) being pressed axially not by the annular front section 123 of the coupler-end contact-making section 121 but by a different section of the coupler outer conductor 113. In the embodiment shown, an axial stop limit between plug and coupler is provided by the annular end face 231, which belongs to the outer conductor 213 of the plug 200 and which penetrates the annular outer-conductor groove 119 of the coupler outer conductor 113, being arrested axially by the groove floor 119a of this outer-conductor groove 119, so that on tightening the coupling nut 223, the maximum axial pressures are produced here between coupler and plug by applying suitable torques to the coupling nut.

Unlike the prior art, however, a radial signal path is now provided separately from the mechanically acting axial stop limit, for which purpose the coupler 100, for example, is provided with a socket outer-conductor contact (or a contact acting as a socket) and the plug 200 interacting therewith is provided with a pin outer-conductor contact (i.e. at least one pin-shaped or sleeve-shaped outer-conductor contact), via which said radial signal path can be created. In other words, the electrical signal path hence runs via the (pin) coupler outer-conductor contact-making section 121, which is annular or hollow cylindrical in shape and lies inside the sleeve-shaped or cylindrical plug outer conductor 213 (socket outer-conductor contact), and which is encircled thereby, wherein the coupler outer-conductor contact-making section 121 is provided with a contact-making area 121a protruding radially outwards. This contact-making area 121a preferably lies at least near the unattached end of the coupler outer-conductor contact-making section 121, i.e. at least near or adjacent to the front face 123, which limits the coupler outer-conductor contact-making section 121 in the direction of the plug 200. The contact-making areas 121a are here embodied in the form of ridges protruding radially outwards, which project beyond the adjacent surface sections that face radially outwards of the outer conductor 113, i.e. coupler outer-conductor contact-making sections 121.

Again in this case, in a preferred variant, the coupler outer-conductor contact-making section 121 is divided by a multiplicity of slits 121b, which are mutually spaced in the circumferential direction of the coupler outer-conductor contact-making section 121 and preferably run in the axial direction, into a multiplicity of outer-conductor spring-loaded tabs 121c spaced in the circumferential direction, which are held pressed against the cylindrical inside wall 213a of the plug outer conductor 213 with an initial spring tension (this principle is also illustrated and explained in more detail below in a further discussion with reference to FIG. 2a). The contact-making area 121a formed at each of the outer-conductor spring-loaded tabs or contact tabs 121c is made in the form of radially protruding ridges, without being limited to this embodiment.

In this embodiment shown in FIG. 1, a gap 11′ is then ultimately formed between the front face 123 on the coupler outer-conductor contact section 121 and the corresponding annular shoulder 217 on the plug outer conductor 213, so that here, unlike the prior art, there is no signal path between the two coupled connectors 100, 200, i.e. no galvanic contact between the coupler 100 and the plug 200.

Since the current on the coupler outer conductor 113 only flows over the inside wall 113a, this also results in only the initial spring-tension forces between the coupler outer-conductor contact tabs 121c and the inside wall 213a of the plug outer conductor 213 being crucial to signal transmission and no longer the axial contact pressures between the two mechanical stops acting in the axial direction, which are formed by the groove floor 119a of the coupler outer conductor 113 and the front face 231 of the plug outer conductor 213.

The embodiment shown in FIG. 2 differs from that of FIG. 1 in that an insulator 233 is also provided in the gap 11′ between the front face 125 of the coupler outer-conductor contact tab 121c and the corresponding annular stop shoulder 217 lying inside, so that the electrical signal path, as in the exemplary embodiment of FIG. 1, is made in the radial direction between the coupler outer-conductor contact tabs 121c lying inside and the plug outer conductor 213 lying outside, i.e. encircling the coupler outer-conductor contact tabs, and the mechanical contact pressure, which is exerted by the coupling nut 223, can only act in the axial direction. In this case, it would even be possible to dispense with the front-face limit of the plug outer conductor 213 arrested by the groove floor 119a. The tolerances can also be chosen so as to produce axial tensioning at both points. In order for the insulator ring 233 to rest against the leading connecting or insertion face, it is also provided with a cylindrical lip 233b (FIG. 2) in addition to its annular section 233a (which generally lies at right-angles to the axial direction 300), so that the insulator 233 formed in this way, when suitably dimensioned, can be mounted onto the end of the coupler outer conductor, i.e. the spring-loaded tab 121c, and is held there even before being connected together with a plug.

In this case, the insulator 233 and the front face of the contact tabs 121c of the coupler outer-conductor contact section 121 is formed and/or shaped so that, on inducing the torque via the coupling nut 223, the induced axial forces between the annular shoulder 217 and the insulator 233, which is annular, for example, exert forces on the front face 123 on the contact tabs 121c, which help to increase the outwards-directed radial forces on the contact tabs 121c, and thereby the contact sections 121a on the contact tabs 121c press even more strongly in a radial direction against the inside wall 213a of the outer conductor 213 of the plug 200 and thereby further improve the electrical signal path if necessary.

In this embodiment, said insulator or insulator ring 233 is preferably permanently fixed to the coupler 100 (which is indicated by the fact that the cylindrical lip 233a is clamped against the inside wall of the plug outer conductor 213), so that a coupler such as that shown in FIG. 2 and a coupler as shown in FIG. 1 can also be placed with a conventional plug of a corresponding connector, because the plug 200 in the embodiment of the connector known in the prior art and shown in FIG. 7 has remained unchanged, and also for the variant shown in FIG. 1 and FIG. 2 a conventional plug can be used with the coupler according to the invention.

A variant of FIG. 2 is discussed below.

The embodiment shown in FIG. 2a is based on an arrangement of the two coupled connectors 100, 200 that is substantially identical to that of FIG. 2. FIG. 2a shows a development of the coupler outer-conductor contact-making section 121 that approximates a hollow cylinder in shape, which comprises said outer-conductor spring-loaded or contact tabs 121c, which are separated from each other by slits 121b. In this embodiment, however, not just contact tabs 121c are provided lying side-by-side, but in this illustrated embodiment an outer-conductor support section 121d is provided alternately (although a different solution can also be used) beside an outer-conductor spring-loaded or contact tab 121c, said support section extending beyond the contact tabs or spring-loaded tabs 121c in the insertion direction, i.e. in the axial direction. Instead of an outer-conductor section 121d which protrudes axially a long way being provided between at least every two spring-loaded tabs 121c, it may also suffice if in total just one or two, i.e. fewer or more even, outer-conductor support sections 121d are provided as outer-conductor spring-loaded tabs 121c.

In addition in this embodiment, an insulating body, for example in the form of an insulating ring 233, is also provided, which is provided between the downwards-facing front faces 123 of the coupler outer-conductor contact section 121 and the corresponding annular stop shoulder 217 of the plug outer conductor 213, for example by suitable design, is also held at least by a friction fit on the outer-conductor support sections 121d protruding in an axial direction. When the coupling nut is tightened, the leading front faces 123 of the coupler outer-conductor contact-making section 121 hence run up against the corresponding plug outer-conductor stop 217, via the intermediary of said insulator 233, so that corresponding axial pressures, induced via the coupling nut, act here. Once again, the tension between the two outer conductors of the connectors 100 and 200 acting in the axial direction is hereby separated from the radial signal path across said contact sections 121a of the contact tabs 121c. In other words, the radio frequency signal path always runs over the conducting surfaces facing the interior I (where the interior I is that space in which the inner conductors 101 and 201 of the connectors are also present). In other words, the electrical connection is made along the RF signal path from the inside walls 113a in contact with the interior I, across the surface, which bounds the interior I, of the inside wall of the radial contact-making arrangement and from there to the inside wall 213a of the nearest connector 200, from where the RF signal path then continues e.g. to an outer conductor of a coaxial cable that can be connected to the connector 200. The axial stop acting between the groove floor 119a of the outer conductor 113 and the annular front face 231 of the other outer conductor 213 hence lies removed and/or shielded from the interior I, i.e. separate therefrom. In other words, the RF signal path spreading only over the electrically conducting surfaces bounding the interior I does not run via the axial stop, and therefore this axial stop is separate from the RF signal path.

FIG. 3 is used to show that the coupler housing 115 can be divided into two parts in the radial direction, and has a conducting coupler outer conductor 133, which is arranged inside, and in this case is encircled by a coupler outer-conductor housing 115 that encircles this coupler outer conductor 113, which can be made, for example, from an insulator, in particular in the form of a plastic, although also any other material can be used, for instance also aluminium etc.

In the embodiment shown in FIG. 3, the coupler outer-conductor housing 115, which is made of a material that is not electrically conducting, is shaped so that it also forms the groove floor 119a and the external-thread housing section 118, and having the annular front-face limit 125 that faces the plug, so that said seal 220 is arranged between the coupler housing made of plastic and the annular shoulder 221, on which seal suitable pressures act. The inside boundary surface of the groove-shaped recess 119 is in this case formed by the coupler outer conductor 113 having the coupler outer-conductor contact section 121, which, as explained, is preferably divided into contact fingers running in an axial direction, which rest against the outer conductor of the plug by outwards-acting initial spring-tension forces.

A further modified embodiment shown in FIG. 4 is discussed below, which differs from that of FIG. 2 in that the coupler outer-conductor contact section 121 is shortened further and extends in an axial direction only over a partial length of the coupler outer-conductor threaded body 118 and/or of the plug outer conductor 213, in particular with respect to the ledge 215 projecting radially inwards.

In the embodiment shown in FIG. 1, the axial length of the coupler outer-conductor contact section 121 and the extent of the contact conductor tabs 121c viewed from the groove floor 121a equals about 70% to 90%, preferably 90% to 95% of the axial length of the plug outer conductor that extends axially beyond the stop shoulder 217.
In the embodiment shown in FIG. 4, the coupler outer-conductor contact section 121 viewed in the axial direction is now considerably shortened, so that the coupler outer-conductor contact section 121 comes to lie with the contact tabs 121c close to the groove floor 119a. In other words, it can be stated that the coupler outer-conductor contact section 121 can overlap the plug outer conductor 123 along its axial length in a region of 1% or 5% to 95% or even 99% without a problem, i.e. overlap the plug outer conductor 213 in the area between its annular front face 231 at the connecting or plug end and its inwards-projecting annular shoulder 217 on the ledge 215. There are no dimensional restrictions in this respect.

Here, the contact tabs 121c are preferably provided in the end region of the coupler outer-conductor contact section 121, but can also be provided at a position removed from this front face 123.

The embodiment shown in FIG. 4a substantially corresponds to that of FIG. 4, wherein (although not necessary) the corresponding outer-conductor contact-making section 121 is designed to be even longer in the axial direction, protruding completely freely in the axial direction and performing no function per se. The actual contact-making arrangement acting in the radial direction also again runs via the radially protruding contact-making areas 121a, as explained with reference to the previous embodiments.

In addition, the radio frequency signal path HF-S running over the inside walls 113a and 213a of the couplers to be connected is sketched in FIG. 4 as a dash-dotted line. In other words, this radio frequency signal path, as already mentioned several times, only ever runs over the inside faces or surfaces, which bound the interior I, of the electrically conducting parts (where the interior I inside the outer conductor is that area in which the inner conductors 101, 201 also run). The contact-making section 121 (performing no function per se) that extends beyond the radial contact-making arrangement having its contact-making area 121a can be used, however, to illustrate how this RF signal path always runs over the inside walls of the outer conductors or of the radial contact-making arrangement that bound the interior I. In other words, this RF signal path hence runs past the axial end stop, which lies separate (and hence shielded) from the inside walls (i.e. surfaces) of the outer conductors and of the radial contact-making arrangement. This applies also, for example, even to the embodiment shown in FIGS. 1, 3 and 4, because in this case the axial (galvanic) stop is always provided outside the RF signal path, in other words hence away from the inside walls of the outer conductors and of the radial contact-making arrangements. Thus since the radio frequency current can only flow over the conducting surfaces that bound the interior I and not through the metal, and also the described axial contact between the connectors lies, so to speak, “behind” these surfaces (over which the RF signal path HF-S runs), then this realises the separate formation of this RE signal path from the axial stop. In other words, a conducting mechanical axial stop hence must not be present in the inner (coaxial) area, i.e. in the direct inside-lying RF connection path between the inside walls of the individually coupled outer conductors. This guarantees that the mechanical axial stop does not affect the electrical properties of the connection.

The embodiment shown in FIG. 5 is now used in the sense of an inverse and transposed design to illustrate that an outer-conductor contact section 241 can also be formed on the plug outer conductor 231, preferably likewise in the region of the annular front end 231. Here, contact tabs 241c are formed, preferably projecting radially inwards, which lie in contact with the contact surface facing radially outwards of the coupler outer-conductor section 121.

In this case, even the axial pressures between coupler and plug can act between the radial front face 231 of the plug and the groove floor 119a of the coupler 100 without there being an insulator, e.g. plastic, interposed here. This is because, despite galvanic contact, the RF signals and RF currents flow over the inside wall 113a, so that only the purely mechanical pressures act in the axial direction, and only the radial signal path between the outer-conductor contact section 241 plus the outer-conductor contact tabs 241 and the coupler outer conductor 113 is crucial to current transmission and signal transmission. In this embodiment, the coupler outer-conductor contact section 121 likewise again has a shortened design in an axial direction, in a similar manner to the embodiment of FIG. 4. Again in this embodiment, the actual contact tabs 241c are formed with corresponding ridges protruding radially inwards, which are the means of making contact radially with the outer-conductor section of the connector 100, because the ridges project beyond the adjacent surface sections that face radially inwards of the outer-conductor contact tabs 241c.

FIG. 6 is used to illustrate an embodiment in which the coupler according to the invention and/or the plug according to the invention can be provided in the sense of an adapting device and/or an intermediate connector, for example between an antenna housing and an amplifier arrangement (TMA).

FIG. 6 also shows schematically, for example, an antenna housing at the top, more particularly the underside 11a of an antenna housing 11, with the upper side 13a of an adjacent housing of an electrical/electronic device 13, for example an amplifier housing (TMA housing), being set apart therefrom.

A plurality of cable connections are provided between the two according to the prior art.

Alternatively, it is now possible to provide, for example on the underside of the antenna housing, the coupler 100 according to the invention that was explained using the aforementioned embodiments, with it being possible to attach, on the corresponding upper side 13a of the electrical/electronic device 13 to be attached, the conventional plugs 200 that interact therewith or the couplers 100 and plugs 200 that are modified compared with the prior art and were illustrated, for example, using FIGS. 4 and 5. This creates the possibility that a corresponding electrical or electronic device 113, for example in the form of a TMA, can be connected to an antenna solely by the electrical/electronic device 113 being inserted by its connector or its connector combination in the appropriate connector or the appropriate connector combination on the other device, in this case on the antenna housing. Temperature-induced axial changes in position between the coupled connectors (which form a coupled connector assembly) are immaterial in the sense that the signal path is always reliably maintained, because it is made in the radial direction between the conducting-out sections between the interacting outer-conductor sections between the coupled connectors (coupler, plug), and not in the axial direction, as is the case in the prior art.

It would also be possible in this respect to implement, for example, the one connector as a dual plug or as a dual coupler, which like an adapter piece (intermediate connector) has a plane of symmetry running perpendicular to its axial direction. Such an intermediate connector could then, if it were made in the form of a symmetrical intermediate connector, be interconnected between two coupler connectors as an intermediate connector. The inverse design would be equally possible, if the intermediate connector were designed as a dual coupler, which would then interact with a corresponding mating part (plug) at its two opposite connecting parts.

The connectors used as part of the invention can serve generally as connectors for cable connections, or else also as coaxial cable connections in those cases in which, for example, connectors designed as couplers or plugs are permanently fixed to a housing of an electrical/electronic device. Hence a connector according to the invention can also be integrated well in a device, for instance in an antenna, an antenna housing, an amplifier, a filter etc., and therefore a device equipped with such a connector can be electrically connected without difficulty to a standardised or commercial connector interacting with this device. Here, the connector connected to the device can, according to the electrical requirements of the device and the signal path provided thereby, also be equipped differently from standardised connectors, i.e. be designed so that only the key electrical values required for the device concerned need to be met, which applies, for instance, to an operating frequency range to be transmitted, environmental rating requirements, number of mating cycles etc.

The invention has been explained with reference to connectors for which either a pin contact or a socket contact is designed as the inner conductor. The invention can equally be applied, however, to connectors for which the inner conductor to be coupled has an hermaphroditic contact, which hence can be designated neither a pin contact nor a socket contact. Preferably, however, inner-conductor contact is made with a radial contact path.

For the connectors mentioned, it is immaterial to the invention whether the connector provided with a socket outer-conductor contact has a pin contact or a socket contact as the inner conductor. Likewise, it is immaterial whether the connector provided with a pin outer-conductor contact (i.e. in the form of a hollow-cylinder outer conductor where contact is made on the outer surface) is equipped with an inner conductor that is socket shaped or pin shaped. It is likewise immaterial on which of the two connectors a coupling nut is provided, which interacts with a matching external thread of the other connector.

1. Connector comprising:
an outer conductor and/or an outer-conductor housing,
an inner conductor,
an insulator centering washer structured for fixing and holding the associated inner conductor,
a mechanically acting axial stop located on the connecting or insertion end of the connector,
an electrical outer-conductor contact-making section on the connector outer conductor and/or on the outer-conductor housing structured for making electrical contact with an outer conductor of another connector, and
a radio frequency signal path, which runs over the inside wall of the outer conductor of the connector to the inside wall of the outer conductor of another connector to be connected thereto,
the electrical outer-conductor contact-making section of the outer conductor of the connector being designed to run in the radial direction separately from the axial stop so that the radio frequency signal path, formed on the inside walls of the outer conductor, runs between the outer conductor of the connector and another outer conductor to be connected thereto of another connector via the electrical contact-making arrangement running in the radial direction, and
the mechanically acting axial stop on the connecting or insertion end of the connector is provided outside the radio frequency signal path defined by the radial contact-making arrangement.

2. Connector according to claim 1, further comprising an insulator provided on the mechanically acting axial stop, on the connecting or insertion end on the front face, which is the leading face in the insertion direction, on the coupler outer conductor or on the coupler outer-conductor contact section and/or is provided on the insertion stop limit on the plug outer conductor.

3. Connector according to claim 1,
wherein the direct radio frequency signal path runs between the inside walls of the outer conductors to be coupled via the inside wall of the radial contact-making arrangement, whereas the axial stop on the connecting or insertion end of the connector lies removed and/or shielded from the inside walls of the outer conductor and from the electrical contact-making arrangement running in a radial direction.

4. Connector according to claim 1, wherein the electrical contact-making arrangement on the outer connector comprises an outer-conductor contact section that protrudes radially outwards or inwards from the central axis of the connector.

5. Connector according to claim 1, wherein the outer-conductor contact section is embodied in the form of a ridge protruding radially outwards or radially inwards, which projects beyond the adjacent surface sections that face radially outwards or radially inwards of the outer conductor.

6. Connector according to claim 1, wherein the outer-conductor contact section is provided in the end region of the outer conductor on the connecting or insertion end of the connector.

7. Connector according to claim 1, wherein the outer-conductor contact section comprises a plurality of elastic contact tabs, which are spaced in the circumferential direction and which can be reversibly deformed in the coupled state with another connector.

8. Connector according to claim 1, wherein the hollow cylindrical outer-conductor contact section is divided by a multiplicity of slits, which are mutually spaced in the circumferential direction, into a multiplicity of outer-conductor spring-loaded tabs spaced in the circumferential direction, which, in a coupled state with another connector, rest against the contact face of the outer conductor of the other connector with an initial spring tension.

9. Connector according to claim 1, wherein at the connecting or insertion end of the connector, the front face, which is the leading face in the insertion direction, on the outer-conductor contact section terminates before the front face, which is the leading face in the insertion direction, on the outer-conductor thread of the connector.

10. Connector according to claim 1, wherein the outer conductor is divided into a plurality of outer-conductor spring-loaded tabs in the circumferential direction, wherein
at least one outer-conductor support sections, spaced in the circumferential direction, are provided at least between two spring-loaded tabs and between a plurality of pairs of spring-loaded tabs, said support sections extending beyond the outer-conductor spring-loaded tabs in the axial insertion direction.

11. Connector according to claim 1, wherein the connector is designed as a connector having an inner-conductor coupler contact or as a connector having an inner-conductor pin contact, i.e. in which contact is made in a radial direction.

12. Connector according to claim 1, wherein the connector is designed as an unattached connector or as a fixed connector, in particular in the form of a coupler or a plug.

13. Connector according to claim 1, wherein the connector is designed as a fixed connector that is attached or fitted on a housing or on a device and whose electrical properties have been adapted to suit the device properties.

14. Connector according to claim 1, wherein the connector has a socket outer-conductor contact.

15. Connector according to claim 1, wherein the connector comprises a pin outer-conductor contact shaped as a hollow cylinder or like a hollow cylinder, for which electrical contact is made on the outer surface of the pin outer-conductor contact.

16. Connector assembly containing a connector according to claim 1, wherein the connector is used or can be used with another connector to form a coupled connector assembly.

17. Connector assembly according to claim 16, wherein the outer-conductor contact section of the one connector extends in a region between 1% to 99% of the length of the outer-conductor contact section of the other connector, i.e. in a region between an annular front face and a preferably annular stop shoulder on the outer conductor of the connector.

18. Connector assembly according to claim 17, wherein the hollow cylindrical outer conductor of the one connector engages in an annular or hollow cylindrical outer-conductor groove in the other connector.

19. Connector assembly according to claim 18, wherein the annular front face, provided on the connecting end of the one connector, on the outer conductor is held pressed against the groove floor of the annular outer-conductor groove and/or the front face at the connecting end on the outer-conductor contact section is held pressed against a connecting shoulder of the outer conductor of the coupled other connector with interposition of an insulator.

20. Connector assembly according to claim 16, wherein the outer-conductor contact section of the one connector extends in a region between 1% to 50%, in particular in a region between 1% to 20% or 10% to 10% of the length of the outer-conductor contact section.

21. Connector assembly according to claim 16, wherein the front face, which is the leading face in the insertion direction on the connecting or insertion end, on the outer-conductor contact section of the one connector terminates before the front face, which is the leading face in the insertion direction, on the outer-conductor thread of the connector.

22. Connector assembly according to claim 16, wherein the connector can be coupled or is coupled to an intermediate connector or adapter.
